(19) United States
(12) Patent Application Publication
(10) Pub. No.: US 2023/0035536 A1
(43) Pub. Date: Feb. 2, 2023

(54) ORCHESTRATION OF AN EXCHANGE PROTOCOL BASED ON A VERIFICATION PROCESS

(71) Applicant: Rodney Williams, Cincinnati, OH (US)

(72) Inventor: Rodney Williams, Cincinnati, OH (US)

(73) Assignee: Solo Funds Inc., New York, NY (US)

(21) Appl. No.: 17/966,337

(22) Filed: Oct. 14, 2022

Related U.S. Application Data
(63) Continuation of application No. 15/248,862, filed on Aug. 26, 2016.
(60) Provisional application No. 62/210,619, filed on Aug. 27, 2015.

(51) Int. Cl. G06Q 40/02; G06Q 20/10

(52) U.S. Cl. CPC G06Q 40/025; G06Q 20/102; G06Q 50/01

(57) ABSTRACT

A computer-implemented method for facilitating an exchange between two mobile devices based on a request via a platform. The method includes initiating a verification process of at least one social media account and a profile of a first user via an interprocess communication with a social media application installed on the mobile device of the first user. The method may further include assigning a score to the first user based on content of the at least one social media account or the profile of the first user and based on results of the verification process. The method may further include, after a determined period of time, and without direct action on behalf of the first user, directly accessing a source owned or controlled by the first user and transmitting at least a portion of a payment to the second user.

### CROSS-REFERENCE TO RELATED APPLICATIONS

This application claims priority to U.S. Patent Application Serial No. 15/248,862, filed on Aug. 26, 2016, which claims priority to U.S. Provisional Patent Application Serial No. 62/210,619, filed on Aug. 27, 2015, and the entire contents of both of these applications are hereby incorporated by reference.

### TECHNICAL FIELD

The present invention is directed to a mobile-to-mobile facilitated lending platform, and more particularly, to systems and methods for mobile-to-mobile facilitated lending platforms that enable an exchange of funds between borrowers and lenders.

### BACKGROUND

Certain individuals and households may be underbanked, unbanked, or make significant use of alternative banking or loan services, such as short term payday loans, loans secured by vehicle titles, and personal loans provided by family and friends. Many individuals and households also lack sufficient emergency savings funds. Thus many individuals and household may require, from time to time, loan funds to meet various short term expenses. Many individuals who take advantage of such loan opportunities also make frequent use of smartphones and other mobile technologies over a variety of platforms.

### SUMMARY

In one embodiment, the invention is a system which creates a system and network for addressing relatively low value loans through a mobile platform. More particularly, in one embodiment the invention is a computer-implemented method for facilitating loans including receiving a loan request specifying a requested loan amount from a plurality of borrowers via a lending platform. The method includes reviewing at least one social media account or profile of each of the plurality of borrowers, and assigning a credit score to each of the borrowers based at least in part on content of the at least one social media account or profile of each borrower. The method further includes providing information relating to the requested loan amount and the assigned credit score of each of the plurality of borrowers to a plurality of lenders via the lending platform, and enabling each lender select at least one of the potential borrowers to receive loaned funds from the lender.

### BRIEF DESCRIPTION OF THE DRAWINGS

FIG. 1 is a flow chart diagram illustrating one embodiment of a method for facilitating a loan transaction;

FIG. 2 illustrates a mobile device displaying one embodiment of a log-in screen for accessing a mobile lending platform;

FIG. 3 illustrates a mobile device displaying a screened list of borrowers seeking funds in the mobile lending platform;

FIG. 4 illustrates a mobile device displaying additional details relating to a particular borrower in the mobile lending platform; and

FIG. 5 illustrates a mobile device displaying certain exemplary notifications provided to a user in the mobile lending platform.

### DETAILED DESCRIPTION

In one embodiment the present system is a computer-implemented, mobile-to-mobile facilitated lending platform that enables exchange of funds, such as low-value funds, between borrowers and lenders. The lending platform can be administered and/or owned by a lending platform provider that can set up, maintain, and control access to and use of the lending platform. In one case the lending platform can take the form of a lending platform that is accessible as a mobile application for mobile devices.

The lending platform may define, maintain and/or support a loan or lending marketplace where borrows can seek or solicit loans which potential lenders can review and accept if desired. Borrowers may access the mobile-to-mobile facilitated lending platform to request loans, and lenders may access the lending platform to offer loans and collect interest. Borrowers and lenders may also use the lending platform to review and monitor their accounts, and can interact on a direct and individualized peer-to-peer basis to negotiate loan terms. The borrowers and the lenders (collectively, the “users”), may in one case each be individual human persons and not entities, businesses, banks, organizations, pools of individuals (except in the case of a co-signer), or the like. Each borrower and lender may be able to access and fully utilize the lending platform by their mobile devices.

The lending platform provider may charge fees to the borrower, the lender, or both, for use of the services provided by the lending platform on a per-transaction basis, on a subscription basis, or the like. The system and method disclosed herein may calculate and/or utilize a score or measure of credit worthiness (or a credit worthiness score or metric or value) for each user which can be termed a “social credit score” herein. A social credit score may be calculated for the borrower, the lender, or both, based at least in part on information derived from that user’s social media activity and/or connectiveness, as monitored by the system or the user’s mobile application. The user’s social credit score may be used to define that individual user’s permissions, authorization, borrowing/lending limit and/or scope of use on the lending platform. Accordingly, the user’s social credit score may determine which services and/or functions that user is authorized utilize, and/or the extent to which that user may utilize such services and/or functions. The social credit score can also be considered an indicator of how likely a borrower is to repay a loan and/or an indicator of how likely a lender is to fulfill the lender’s obligations. The social credit score is not necessarily a static value, but rather an evolving metric that can change over time (positively or negatively) based on any of a variety of factors related to the user’s activity both within and outside the lending platform, as will be described in greater detail below.

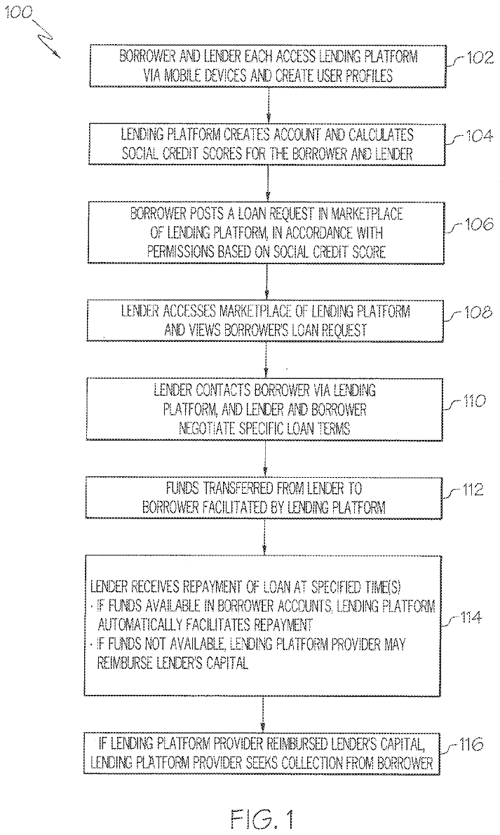

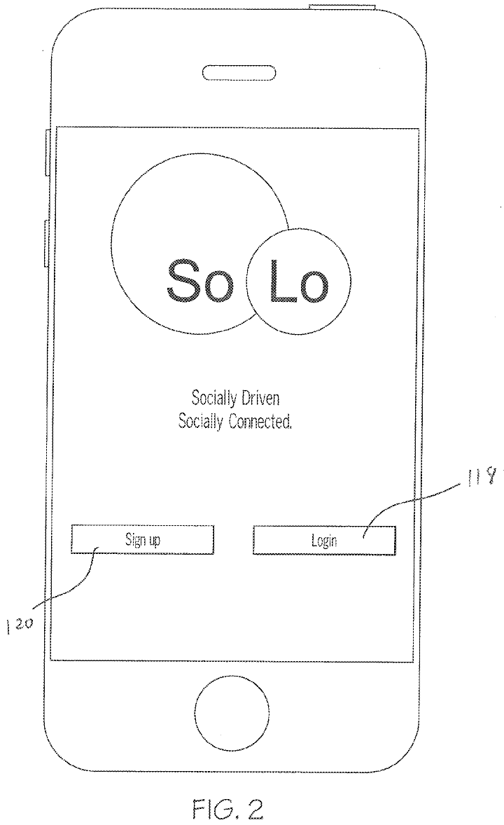

Referring now to FIG. 1, certain basic principles of a method 100 for use of the lending platform is shown. At step 102, the borrower and lender each access the lending platform, in one case via mobile devices such as a cell phones, smart phones and/or tablets, in one case that are small and light enough to be manually held and operable via a display screen with touch input. The access of the lending platform by the borrower and lender of course need not be contemporaneous. As part of the initial access of the lending platform the borrower and lender may each be required to register with the lending platform. For example, when initially accessing the mobile lending platform, a user may be presented with a screen image shown in FIG. 2. A user which has already registered can proceed to login by activating button 118, while a user who has not already registered or created an account can do so by activating button 120.

The user is then directed to a data-input screen to create an account, which can involve creating a user profile, creating usernames and/or passwords and/or providing various types of bibliographic or personal information, which is then transmitted to and/or stored by the lending platform. For example, in various embodiments, the user may enter or provide of one or more of the user’s full legal name, home address, work address, date of birth, telephone number(s), email address(es), identification photograph, social security number, driver’s license number, bank account information, credit and/or debit card information, occupation, login/credential information required to access the user’s bank account, or other sources of funds and/or payment systems and/or online money transfer systems such as PAYPAL, GOOGLE WALLET, APPLE PAY or other mobile wallet service providers. The user may be required to grant the lending platform provider authority to one or more of the user’s accounts/source of funds such that the lending platform provider can, for example, withdraw funds, deposit funds, check balances, etc.

The user also be required or requested to provides links, login credentials and/or information related to one or more of the user’s social media accounts, for example, one or more of the user’s FACEBOOK, INSTAGRAM, LINKEDIN, PINTEREST, GOOGLE+, TUMBLR, YOUTUBE, SNAPCHAT, TWITTER, REDDIT, PERISCOPE, or MYSPACE accounts, or the like. A borrower may also be requested or required to enter information relating to the nature of the need for or the purpose of the loaned funds (e.g. car repair; travel; credit card payment; etc.)

Certain information may be required for access to the lending platform, such as, in one embodiment, the user’s name, date of birth, social security number, bank account number, an email address, and a link to at least one social media account, while other requested information may be optional. However, as discussed in more detail below, entry of additional requested, but optional, information may improve a user’s social credit score, which can thus increase the user’s ability to transact more freely on the lending platform and/or improve terms available to the user. Inputted user data may be encrypted before transmission to the lending platform provider to protect sensitive personal information. Each user may be required, requested or enabled to sign up with a co-signer who can share all or part of the user’s legal obligations relating to then loan transaction. In that case the co-signer may be required, requested or enabled to enter the same information as the other users as outlined above.

Referring now to step 104 of FIG. 1, after the user’s information is entered and processed/approved, the lending platform provider can create an account for that user. In addition the lending platform may determine and assign a social credit score for each user. The social credit score is a metric by which the lending platform at least partially assesses the creditworthiness of the user. Thus the social credit score can affect the permissions and authorities assigned by the lending platform for the user to, among other features, define borrowing limits, define loan rates, etc.

In one embodiment, the social credit score value for a user ranges from 0 or 1 to 100, where 100 represents the maximum, best, or optimal score. The social credit score range may alternatively be defined such that a lower score, rather than a higher score, indicates increased creditworthiness. In such an embodiment, for a score range from 1 to 100, the “maximum” (i.e., the best or optimal) score could be 1 and the “minimum” score could be 100. However, any of a variety of alternative ranges may be selected with any maximum and minimum value, for example 0 to 1000, 1 to 10, 200 to 400, or -50 to 50, or various others. The pertinent consideration for evaluating credit worthiness could thus be how a particular user’s score relates to the potential range of scores as a whole, not the value of the score in the absolute.

The user’s social credit score is in one case calculated based various factors, including in one case the user’s activity level on the lending platform, the user’s track record for reliability on the lending platform, the user’s social media activity and/or the user’s connectiveness to other social media users and/or the user’s FICO credit score provided by Fair Isaac Corporation located in San Jose, California USA, or other credit score provided by other entities. In other embodiments, the social credit score is entirely separate and distinct from the user’s conventional FICO or other outside-generated credit score, and the FICO or other outside-generated credit score plays no role in determining the user’s social credit score. In one case the user’s social credit score is based upon FICO or other traditional credit score measures, and also the user’s social media activity and relationships, which can be termed the user’s “social capital.”

In some embodiments, a user may have the option to decide whether to authorize the lending platform provider to access the user’s FICO or other outside-generated credit score, and in some cases the authorization can affect the user’s social credit score and/or their permissions or extent of permissions on the system. For example, in one embodiment, the user’s maximum social credit score may be capped at a first maximum score, for example 100 (e.g., where the score ranges from 1 to 100, with 100 being the best), if the user authorizes access to the FICO credit score, but the user’s maximum social credit score may be capped at a second, lower maximum score, for example 80, if the user denies access to or use of the FICO credit score.

In another embodiment, the decision whether to authorize access to or use of the user’s FICO credit score may not impact the user’s social credit score, but may instead or in addition effect the maximum borrowing amount available to the user. For example, a user who denies access to or use of the user’s FICO credit score may be provided with a lower maximum borrowing amount compared to that for a user who authorizes the lending platform provider to use or access the user’s FICO score. Alternatively, rather than affecting maximums, providing access to the FICO credit score may otherwise influence the user’s social credit score and/or lending amounts. In one embodiment, each user’s borrowing and/or lending activity through the lending platform may be reported to one or more credit bureaus, such that user activity on the lending platform may impact one or more of the user’s credit scores available from commercial credit rating agencies.

In one case the user’s social credit score is increased depending upon the number of optional information request fields that the user completes during the registration process (or that the user subsequently provides after initial registration). For example, if the user provides links for each of the user’s FACEBOOK, INSTAGRAM, TWITTER, and LINKEDIN or other social media accounts, the social credit score may for such a user may be higher than a similarly situated user who provides a link only to a FACEBOOK account.

The relative impact of a score increase for completing optional fields in the lending platform database may differ based on the specific type of optional information that is provided. For example, providing a telephone number, a secondary email address, or an identifying photograph may have less of an impact on the social credit score as compared to providing a secondary bank account number, a driver’s license number, or a link to an additional social media account. Even within categories, different information may be weighed differently. For example, providing a FACEBOOK account link may be considered higher value than providing a link to a less popular social media account.

The user’s social media activity entirely outside the lending platform application can also impact the user’s social media score. At least in part, each user’s credit worthiness under the social media score can be based on the user’s level of social network activity, such that the more involved and connected the user is through social media networks, the more potentially trustworthy that user is deemed to be, absent evidence to the contrary (such as unrepaid loans through the lending platform, etc.). The lending platform may review the user’s public and/or private profiles and gather data through the provided links to the user’s social media accounts. The lending platform, through a so-called server (lending platform-operated computer) or the mobile application installed on a user device, can then examine various points of data including one or more of the user’s friend and/or follower counts, post frequency, event participation, bibliographic data, and the like, to determine whether the user’s account on the lending platform is authentic; i.e., that the user account was not automatically generated by a bot or other software system, and that the user’s account registration data is consistent with the user’s social media activity.

A lending platform server may periodically update information concerning the user’s social media/activity profile(s) by accessing the profile, either automatically or at the direction of the user, via the service’s ordinary log-in process. Alternatively, the lending platform server may update information concerning the user’s profiles by cooperative access through an external API interconnecting a social media network to the lending platform or third party services generally. A mobile application may similarly periodically update information concerning the user’s profiles by accessing the profile, either automatically or at the direction of the user, via the service’s ordinary log-in process. Such mobile applications can function through an external API interconnecting a social media network to the mobile application, or by interprocess communication with a social media application installed upon the mobile device. Interprocess communication advantageously reduces the mobile data traffic and battery usage of the mobile application in comparison to automated or user-directed polling of social media activity, particularly as the number of social media services associated with the user’s lending platform profile is increased.

In one embodiment, the lending platform can cross-verify information provided from the user to the lending platform via one or more social media sites. The information gathered by the lending platform can be used to further verify the user’s identity, beyond the information expressly receiving from the user during registration, which can translate to an improved social credit score for the user. If anomalies or inconsistencies are discovered through the scan of the user’s social media information, the user’s social credit score may be negatively affected and/or the user’s lending/borrowing account may be suspended or cancelled pending a more detailed investigation.

In one embodiment, the lending platform provider may provide an additional or premium social media score increase when the user provides information indicating use of particular mobile applications or other products that are owned by, administrated by, or otherwise associated with the lending platform or its business partners, for example through an agreement the lending platform provider has with a particular service provider or product manufacturer. In one embodiment, the maximum positive social media score impact for adding additional optional information is capped at a value less than the maximum social credit score, and, in one embodiment, the maximum positive social media score impact for adding additional optional information is capped at a value less than half of the maximum score (taking into account the minimum score value; e.g., “half” in the context of a range from 100 to 200 would be a score of 150).

The user’s level of involvement and participation on, and use of, the lending platform can impact the user’s social credit score. For example, the user’s past borrowing and/or lending activity through the lending platform (or elsewhere) may impact the user’s social credit score. For example, in the case of a borrower, the borrower’s successful and timely repayment of a loan through the lending platform may increase the borrower’s social credit score, whereas default on repayment through the lending platform may decrease the borrower’s social credit score. Outstanding and/or past-due borrower debts issued or tracked through the lending platform may also decrease the borrower’s social credit score. In the case of a lender, increased loan-making activity through the lending platform may increase the lender’s social credit score. In one embodiment, a user’s social media score may also be improved through endorsement and/or verification of the user’s identity by other users of the lending platform, based on personal knowledge outside of the lending platform relationship (e.g., by friends “in real life”). In one embodiment, users may be able to provide direct feedback, reviews, or ratings of other users, which, in turn, may impact the social credit score. In some cases a social credit score for the lender is not required or tracked, although in other cases the social credit score for the lenders are tracked and/or displayed.

The user’s social credit score can also take into account news, recent developments or other information that may effect the user’s credit worthiness, based upon the user’s geographic location or geographic area (e.g. metropolitan area in one case, or state/province in another case), socio-economic status, job title, employer, timing of the loan request, and other factors, which can be determined based upon the user’s social media accounts or otherwise. For example, in one case the user’s location may be determined and/or tracked, and if there are events such as natural disasters (flooding, earthquakes, tornados, hurricanes, fires, etc.), social unrest, etc. occurring at or close to the time of the user’s loan request or the evaluation of the user’s credit worthiness (in one case, within 2 weeks or in another case within 2 months of the user’s loan request and/or the evaluations), the user’s social credit score may be adjusted accordingly. News, press releases, releases of statistical information or the like that can relate to the user, such as unemployment rate, crime rates and job creation/elimination announcements can also be considered. The timing of the loan request can also be considered; for example if it is determined that a borrower’s repayment will be due close to when a borrower gets paid through their job, the borrower’s social credit score for that loan can be increased.

An algorithm or artificial intelligence system can be developed to determine this aspect of a user’s social credit score, if utilized. This aspect of a user’s social credit score can provide a “real-time” aspect to the user’s social credit score, resulting in a “real time” credit score. Developments that can effect the user’s social credit score can be determined by monitoring traditional media outlets, but can also be determined by monitoring social media accounts, which in many cases provide more timely information than traditional media. This real-time aspect of the user’s social credit score can be particularly pertinent for loans of the type provided under the current system, which can be relatively short term (repayment of 6 months or less in some cases, or two months or less in other cases, or one month or less in even other cases).

Referring now to step 106 of FIG. 1, once a borrower is registered and optionally the borrower’s social credit score is established, the borrower may post a loan request to a marketplace of the lending platform. The borrower may include or be required to include various details in the loan request, such as the borrower’s identity, the borrower’s social credit score (both of which may be automatically provided), as well as any piece of information outlined above which may be requested or required in the borrower’s registration process.

In one embodiment, the amount of the loan request available through the lending platform is restricted to “low value” loans from about US$1 to a maximum of about US$1000. Low value loans define a niche in the lending market that may be unaddressed by banks and other conventional lenders that generally provide loans in higher amounts. In such cases borrowers may sometimes approach friends and families, but in other cases borrowers may be too embarrassed to approach family or friends, and thus struggle to acquire the funds. Moreover, even when borrowers do request and accept such loans, relationships may be strained if the loans are not repaid, even if the actual amount of the loan is not financially significant to the lender.

The value range of the “low value” loan also provides a price point where the pool of potential lenders is relatively large. This is especially true for the low end of the loan range, for example from about US$1 to US$100 or US$1 to US$200. Further, when a borrower is seeking a low value loan of this type, the loan may frequently be sought to meet a pressing, short-term need. In this case the borrower may need access to the funds relatively quickly, and may often be in a position to repay the loan within for example 1, 2, 3, or 4 weeks, or within 1 to 3 months. Accordingly, the lending platform disclosed herein may be well-suited to serve the low value loan market by providing borrowers with quick access to funds, sourced from an arms-length transaction with an individual lender who is known to be interested in providing such a loan. However, in alternative embodiments, the loans available through the lending platform may be used to provide higher value loans, within any suitable range desired by the lending platform provider.

The maximum loan request available to a particular borrower may be further restricted below the maximum generally available through the lending platform. A particular borrower’s personal borrowing limit may be directly correlated with the borrower’s social credit score. For example, in one embodiment, the social credit score scale may range from 0-100 and the maximum loan amount in the lending platform may be, in one case US$1000, where a borrower with a social credit score of 0-30 is restricted to requesting loans of up to about US$50, a borrower with a social credit score of 31-60 is restricted to requesting loans of up to about US$100, a borrower with a score of 61-80 is restricted to requesting loans of up to about US$500, and a borrower with a score of 81-100 is permitted to request loans up to and including the US$1000 maximum. Thus in one case the user’s social credit score bears a direct relation (a generally exponential or linear relationship in some cases) to the size of the loan the borrower can seek.

In one embodiment, each borrower may have only one outstanding loan at a time. In another embodiment, each borrower may have multiple, concurrently outstanding loans, each of which may be in amounts up to that borrower’s maximum. In another embodiment, each borrower may have multiple, concurrently outstanding loans, where the cumulative total loan value is limited to the borrower’s maximum. The borrower’s social credit score may also be used to set specific limits for the number of loans outstanding at one time, the total value of loans outstanding, repayment timeframe etc.

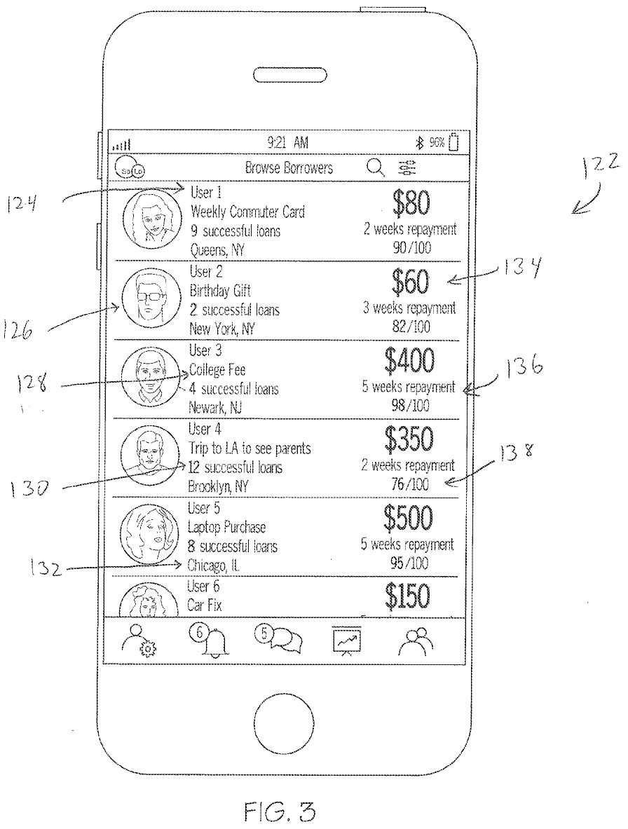

Referring now to step 108 of FIG. 1, a lender may access the marketplace of the lending platform and view information from a number of potential borrowers, each of whom have posted a loan request for a specific amount of funds in accordance with permissions associated with their individual social credit scores, as discussed above. The lender may access a list screened solely by such permissions, or may configure a list screened by personalized criteria such as higher-than-minimum social credit score. FIG. 3 shows one embodiment of a screen display 122 for this aspect of the lending platform. In the depicted embodiment, for each potential borrower, information relating to the proposed loan is displayed, including but not limited to information relating to the borrower’s name 124 (in FIG. 3, borrowers are identified as “User 1, User 2, etc.” but in use the first name and last initial of the borrower may be shown, or more or less name information may alternatively be provided, including a username and/or alias), identifying picture 126, the purpose for the requested loan 128, the number of successful loans for that borrower 130 in the lending platform (e.g. which can include fully repaid loans and/or outstanding loans which the borrower is not in default; the number of unsuccessful loans may also be displayed if desired), geographic location 132, requested loan amount 134, a summary of requested or proposed repayment terms 136, and social credit score 138 for the borrower (shown in FIG. 3 in context with the scoring scale).

More or less information about the borrowers than that shown in FIG. 3 may be provided. For example, in one case the screen display 122 may display only the requested loan amount 134, or the requested loan amount 134 and the borrower’s social credit score 138, or the loan amount 134, the social credit score 138, and the repayment terms 136, and/or more information could optionally be displayed, including interest rates, borrower occupation, or any other information relating to the borrower outlined above.

Inclusion of additional information via the display screen 122 above and beyond the core terms of the borrower’s loan request (i.e., the loan amount 134 and payment terms 136) may provide the lender with background information about the borrower or the nature of the borrower’s request that enhances the social aspect of the lending platform. This added social dimension may improve the lending experience for both the borrower and lender, and may improve the chances of a potential lender making a loan and/or repayment of the loan by the borrower. The social relationship created between an individual borrower and an individual, humanized lender may increase the borrower’s sense of a moral obligation to repay the loan. Thus the individualized loan scenario (one lender, one borrower) might motivate a borrower to repay a loan that, if it had been provided by a faceless bank, or even a pool of individual lenders, the borrower might otherwise fail to repay. However, the relationship between the individual borrower and lender is generally not as close as relationships between the borrower and his/her family or friends, so the borrower is less likely to seek to take advantage or avoid repayment obligations.

In another embodiment, the display 122 includes the requested loan purpose 130, which may motivate the lender to select a particular borrower based at least in part based on a desire to help the borrower meet the specifically-identified objective in the loan request. Thus providing the loan purpose may provide more meaning to the transaction from the lender’s perspective (and possibly the borrower’s), and improve both the lender’s experience on a more personal level as well as the borrower’s tendency to repay if the borrower knows that the lender is responding to the borrower’s specific need.

The lender may be able to customize the display of potential borrowers to predetermine which information about the borrowers will be shown in the marketplace view of the screen display 122. In one embodiment, the lender may enter pre-defined and/or custom search terms to sort and/or narrow the pool of potential borrowers as desired by the lender, for example by loan amount 134, repayment terms 136, social credit score 138, interest rate, transaction history 130, borrower’s geographic location 132, keywords/loan purpose 128, social media contact list and the like, or combinations thereof.

In one embodiment, as a default setting (which may be able to be modified by the lender-user), the display of potential borrowers in FIG. 3 is arranged such that potential borrowers that are located in generally the same geographic area as the lender are presented to the lender ahead of more distant users, to help establish a personal connection between the borrower and lender. Location data may be based on borrower and lender profile information and/or current physical location based on GPS information available through the mobile devices.

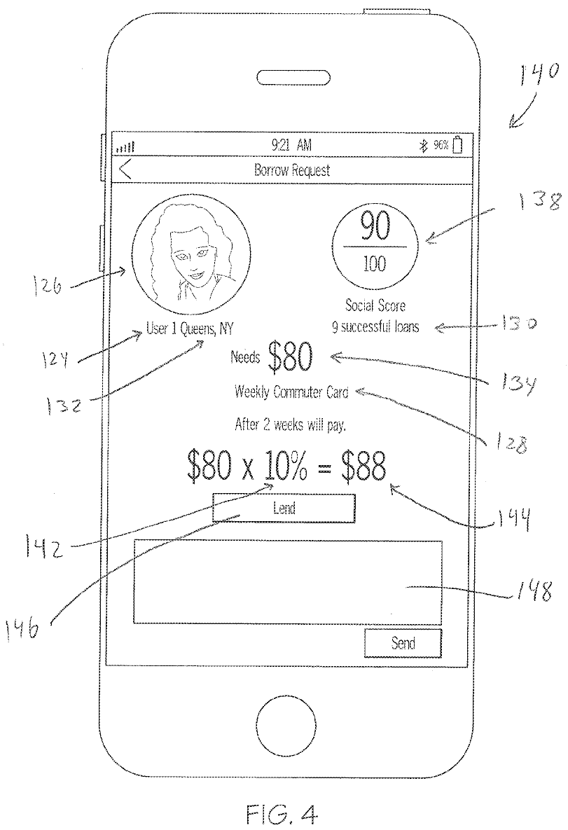

If the lender sees a borrower of interest or wishes to learn more about that borrower, the lender can select a borrower from the list shown in FIG. 2, such as in one case by selecting or touching any information relating to that lender. Such a selection can cause the system/lending platform/mobile device to provide a screen display 140 shown in FIG. 4. The display screen 140 can display the same information about the selected borrower shown in display screen 122 of FIG. 3, although in a different format which may be in a larger font size and more readable. The display screen 140 may also display additional information about the borrower not shown in the display screen 122 of FIG. 3. The display screen 140 may also display additional information such as the proposed interest rate 142 for the loan and the total repayment 144 due the lender (principal plus interest).

If the loan terms are acceptable to the lender, the lender can give his/her consent to the loan such as by selecting the “Lend” button 146. The lender may also enter text or messages to the borrower in the text window 148. When the lender selects the “Lend” button 146, in some cases the loan is automatically accepted by the borrower (in some cases when the borrower has indicated the borrower will accept all loans and does not need to grant subsequent approval). In other cases the fact that the lender is willing to loan money to the borrower may be communicated to the borrower. Various information relating to the lender (such as identity, geographic location, number of successful loans, social credit score, messages entered into the text window 148, or any other information identified above relating to the lender) and information relating to the loan can then be transmitted to the borrower. The borrower can then either accept or decline the loan, or respond to the lender with a counter-proposal, which the lender can then accept or respond to, etc. In cases where the borrower automatically accepts the loan, the same information above can be transmitted to the borrower, along with a notification that the loan has been approved, and in some cases confirmation of the transfer of funds.

As shown in step 110 of FIG. 1, once the lender has selected a potential borrower to whom the lender wishes to loan funds, the lender may directly contact the borrower or contact the borrower through the lending platform. The lender may contact and/or provide loans to multiple different borrowers at the same time, so long as the lender has sufficient funds available to provide the loans and/or is sufficiently authorized. In one embodiment, once the lender contacts the borrower, the identity of lender is disclosed to the borrower. For example, the borrower may, in various embodiments, learn one or more of the lender’s name (all or part), social credit score, geographic location, loan history with the lending platform, and the like.

The lending platform may facilitate lender-borrower communication in any of a variety of ways to finalize the loan agreement. In one embodiment, the lending platform includes a messaging system or other mode of communications link for transfer of messages between the lender and borrower, such as via the window 148 shown in FIG. 4. A similar window for messaging can be provided to borrowers for communicating with lenders. Alternatively, the lending platform may facilitate the anonymous exchange of messages by acting as an intermediary for emails, texts, voice messages, or other communications. These communications can be facilitated directly through the lending platform or through external accounts maintained by the lender and borrower separate and apart from the lending platform. The lending platform may further alternatively provide the lender and/or the borrower with each other’s personal contact information such as a phone numbers, email addresses, and the like. In this case the lending platform provider may first secure permissions from the lender and/or borrower to authorize release of such information to the other party.

If not already specified by the lender and/or borrower and automatically agreed-to, the lender and borrower may next negotiate the specific terms of the agreement. Such negotiable terms may include the loan amount, the loan repayment date/schedule, the interest rate, and various other legal terms (such as recourse for non-payment, dispute resolution procedures, amendments/changes to the legal agreement, etc.). Alternatively, some or all of the loan terms, such as the interest rate, may not be freely negotiable, but rather may be set at specific values based on the social credit scores of the borrower and/or the lender and/or established interest rate benchmarks. Other specific values may be identified by the borrower and/or lender as non-negotiable, or based on requirements and/or preferences of the lending platform provider. In some cases, as will be described in greater detail below, the lending platform provider may guarantee the loan (e.g. payment of the lender’s principal or principal plus interest), while in other cases the lending platform provider does not guarantee the loan.

If the lender and borrower agree to the terms of the loan, the loan process proceeds to the next step. If the lender and borrower do not come to an agreement and the parties do not proceed with the transaction, then no funds are transmitted. If desired the lender and/or borrower may return to the marketplace view of the lending platform to seek additional loan opportunities with different parties.

Referring now to step 112 of FIG. 1, if the lender and borrower successfully come to terms regarding a loan, the lending platform/lending platform provider causes or facilitates transfer of funds from the lender to the borrower in accordance with the agreement between the lender and borrower. The lending platform provider may not directly fund the loan, but instead facilitate the transfer of loaned funds through the lending platform. In one embodiment, the lender and/or borrower may authorize the lending platform to directly access at least one of the lender’s source of funds/money, such as the lender’s bank account, credit card, mobile wallet, spending account, or the like to withdraw funds for deposit with the borrower. The transferred funds can be transferred to a borrower’s source of funds/money, such as the borrower’s bank account, pre-paid card, spending account, mobile wallet, or the like. In one embodiment, the lending platform may be provided with access to the borrower’s debit card onto which the loaned funds are deposited so that the borrower may spend the loaned funds by using the debit card.

Referring now to step 114 of FIG. 1, under terms of the agreement between the lender and borrower, the lender is typically entitled to repayment of the principal at the end of the loan term, or at some other time, plus an agreed upon interest payment or return on investment based on the agreed-to interest rate. In one embodiment, the loan platform provider secures pre-authorization from the borrower (e.g. at the time of the loan, or at the time of the borrower’s sign-up or registration) to directly access the borrower’s bank account or other repayment funding source for the purpose of repaying the lender. Accordingly, when repayment is due, the lending platform may automatically access the borrower’s bank account, withdraw the requisite funds for repayment and interest (plus any fees due the lending platform provider and/or lender, if applicable), and deliver the funds directly to the lender’s bank account or other designated account to receive the repaid funds (less any fees due the lending platform provider, if applicable). By automatically facilitating repayment without further affirmative action on the part of the borrower, the method disclosed herein may improve the likelihood of repayment to the lender. Notice may be provided to one or both parties after funds are transferred.

In one case, at least part of the fees owed to the lending platform are 4% of the initial loan amount due at the time of the initial distribution of loan funds from the lender to the borrower, which can as a default be paid by the lender unless agreed to otherwise. In one case, at least part of the fees owed to the lending platform are 4% of the paid loan amount (either principal or principal plus interest) due at the end of the loan period from the borrower to the lender, which can as a default be paid by the borrower unless agreed to otherwise. In one case, no monthly fees or subscription fees are due, and the only fees owed to the lending platform provider are those on a per-transaction basis, such as those based on the loan amount.

Alternatively, instead of automatically facilitating repayment, the lending platform may require specific authorization by the borrower at the time of repayment before accessing the borrower’s accounts for repayment. The lending platform may send reminders to the borrower from time to time regarding upcoming repayment deadlines through internal messaging functions in the lending platform, text messages, emails, or the like. If full repayment from the borrower is timely received by the lender and/or loan platform provider, the transaction can be considered complete and successful. Accordingly, one or both of the borrower and lender’s social credit scores may be increased as a result of the successful transaction.

If repayment from the borrower is not timely received, for example if borrower’s account from which the lending platform was authorized to automatically collect funds for repayment lacks sufficient funds to complete the transaction, or the account is closed, or access is denied, various remedial measure may be initiated by the lending platform and/or the lender. Failure to timely repay the loan may trigger additional fees owed to the lending platform provider (for example, doubling fees owed to the lending platform) and/or the lender, as specified in the agreement between the lender and the borrower and the lending platform provider’s terms. If the borrower does not timely repay the loan and/or interest, the borrower’s social credit score may also be negatively adjusted.

Upon default by the borrower, or after a pre-determined time period such as 24 or 48 hours following default by the borrower without renegotiation or repayment, the lending platform provider may, automatically in one embodiment, post public reminders of the owed debt through or on the borrower’s social media accounts, if done in compliance with lending/collection regulations. For example, the lending platform my post notice of the default to the borrower’s TWITTER feed, or post a comment referencing the debt owed on the borrower’s wall on FACEBOOK, again if done in compliance with relevant law and regulations. The borrower may be required or requested to consent to the posting and non-removal of such messages, and the granting of such consent may positively affect the borrower’s social credit score. Accordingly, the public messages may motivate the borrower to repay the debt to avoid further embarrassment from the broadcast nature of the unpaid loan to the borrower’s social network. In one embodiment, the lending platform posts at least one time on at least one of the borrower’s social media account pages each day until the debt is settled. In some cases the fee owed to the lending platform may increase (in one case, double) in the event of a default.

In one embodiment, and with reference to steps 114 and 116 of FIG. 1, the lending platform provider guarantees the loan and reimburses the lender for the initial principal/capital and/or the interest due. Such payment/guarantee by the lending platform provider can significantly reduce risk to lender, which can motivate lenders to use the lending platform.

In cases where the lending platform provider has guaranteed a loan and is required to make payment to the lender, reimbursement by the lending platform provider may be delayed until after the loan remains in default for a predetermined period of time, for example 24 or 48 hours. Between the time of the initial default and assumption of the payment/loan by the lending platform provider, the lending platform provider may contact the borrower and/or facilitate communication between the lender and borrower to encourage payment and/or potentially renegotiate the terms of the agreement, such as by modifying the repayment date and/or the interest rate. If the lender and borrower agree to terms on a revised agreement, the loan status in the lending platform may be updated accordingly, and the lending platform provider may avoid assuming the loan and reimbursing the lender.

In an alternative embodiment, the lending platform provider does not guarantee the loan, and the entire risk of default is borne by the lender. Further alternatively, the risk of default may be apportioned between the lending platform provider and the lender in any of a variety of proportions and ways. Yet further alternatively, the lending platform provider may guarantee the loan for a fee. In one embodiment where the lending platform provider assumes at least a portion of the unpaid loan obligation, the lending platform provider may sell or otherwise transfer the right to collect the debt to a third party collections service after a pre-determined period of time without successfully collecting the debt, for example after about 2, 3, 4, 5, or 6 months of nonpayment by the borrower.

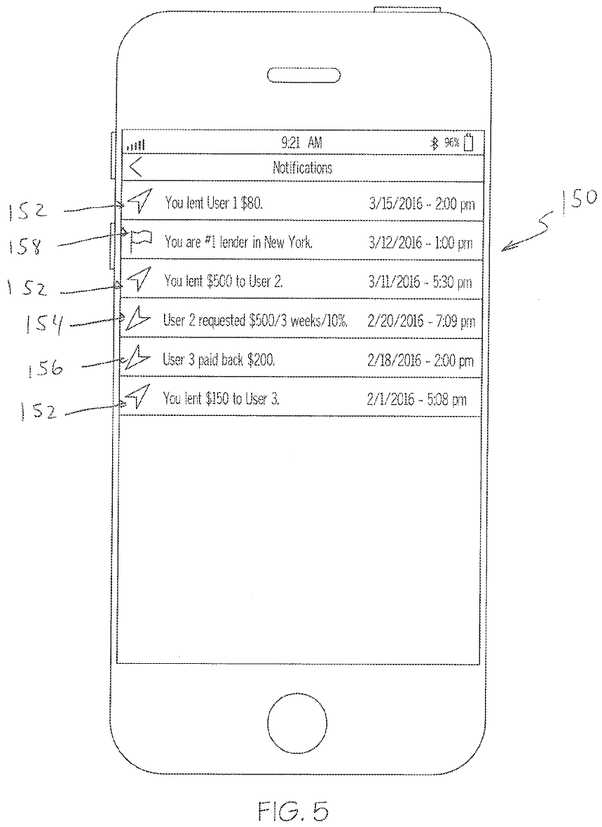

The lending platform can provide updates to both lenders and borrowers. For example, FIG. 5 is a display 150 showing a sample log of activities or notification provided to a particular lender. Lending activities 152 (identifying the borrower, loan amount, date/time, and other information) may be listed. Specific requests from a borrower 154 (identifying the borrower, loan amount requested, repayment terms, date/time and other information) can be displayed and funds received 156 (identifying the source of the funds, the amount of the funds, date/time and other information) can also be displayed. Users can also be rewarded with favorable activity by receiving points, by being able to unlock achievements, and receiving favorable rankings (see ranking notification 158). Such favorable activity can be based upon number of successful loans, number of loans, number of unsuccessful loans, amounts loaned, social credit score, etc.

A computer or computer network can be used by the lending platform provider to set up and/or administer or host the lending platform. As used herein “computer” means computers, laptop computers, computer components and elements of a computer, such as hardware, firmware, virtualized hardware and firmware, combinations thereof, tablet computers, mobile devices, smart phones, or software in execution. One or more computers can reside in or on a server in various embodiments and the server can itself be comprised of multiple computers. One or more computers can reside within a process and/or thread of execution, and a computer can be localized at one location and/or distributed between two or more locations.

The computer can include a memory, a processor, and a user interface (which can include, for example, a keyboard, mouse or other cursor control device, other input devices, screen/monitor, printer, etc.) to receive inputs from, and provide outputs to, a user. The computer can be operatively coupled to a database which can store information relating to the identity of and information relating to the borrowers and lenders, transaction information, distribution of funds, historical data, calculation algorithms, distribution lists, and the like. As used herein “database” means any of a number of different data stores that provide searchable indices for storing, locating and retrieving data, including without limitation, relational databases, associative databases, hierarchical databases, object-oriented databases, network model databases, dictionaries, flat file/XML datastores, flat file systems with spidering or semantic indexing, and the like. Alternatively, or in addition, the same information can be stored in the memory of the computer, which can also be considered a database.

Moreover, such information, including but not limited to the identity of and information relating to the borrowers and lenders, transaction information, distribution of funds, historical data, calculation algorithms, distribution lists, and the like can be stored on software stored in the memory and/or the processor. The software may be able to be read/processed/acted upon by the processor. As used herein, “software” means one or more computer readable and/or executable instructions or programs that cause a computer/processor/device to perform functions, actions and/or behave in a desired manner. The instructions may be embodied in various forms such as routines, algorithms, modules, methods, threads, and/or programs. Software may also be implemented in a variety of executable and/or loadable forms including, but not limited to, stand-alone programs, function calls (local and/or remote), servelets, applets, instructions stored in a memory, part of an operating system or browser, bytecode, interpreted scripts and the like. It should be appreciated that the computer readable and/or executable instructions can be located on one computer and/or distributed between two or more communicating, co-operating, and/or parallel processing computers or the like and thus can be loaded and/or executed in serial, parallel, massively parallel and other manners. It should also be appreciated that the form of software may be dependent on various factors, such as the requirements of a desired application, the environment in which it runs, and/or the desires of a particular designer/programmer. The software may be stored on a tangible medium, such as memory, on a hard drive, on a compact disc, RAM memory, flash drive, etc., which tangible medium can exclude signals, such as transitory signals and/or non-statutory transitory signals.

The computer running the program can also be connected to the internet to receive inputs and provide outputs. The computer can communicate with the internet or other computers via computer communications. For the purposes of this application “computer communications” means communication between two or more computers or electronic devices, and can take the form of, for example, a network transfer, a file transfer, an applet transfer, an email, a hypertext transfer protocol (HTTP) message, a datagram, an object transfer, a binary large object (BLOB) transfer, and so on. Computer communication can occur across a variety of mediums by a variety of protocols, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and various other systems.

The various functions described above may be provided or contained in its own module. For example, the system may utilize a registration module for receiving and updating registration information relating to a user; a social credit score module for calculating and updating the social credit score for each user; a marketplace module for assembling, displaying and processing information relating to the display and acceptance of loans; a communications module for enabling communications between users; a payment module for enabling transfer of funds between users; a loan transaction module for identifying and processing relevant information relating to qualifying a loan; loan modules; calculating modules, and distributing modules for distributing funds. Each step or functionality described herein or specified in the claims can form a separate module. Each module can be a block of software, code, instructions or the like which, when run on a computer, provide the desired functions. Each module may be able to interact with the other modules, and may not necessarily be discrete and separate from the other modules, the reader, or other components of the reader/system. The modules in the system may be functionally and/or physically separated, but can share data, outputs, inputs, or the like to operate as a single system and provide the functions described herein.

As outlined above, there is a need for low value loans, and many persons who need such loans utilize mobile devices. Accordingly, in one embodiment the present invention defines and addresses a market for a lending platform that can quickly, efficiently, and effectively service individuals needing loan assistance by providing or facilitating low value (for example, under US $1000) loans on a short term basis. Such services can be provided on an individualized, peer-to-peer, mobile-based platform which appeals to the needs and technological desires of many potential borrowers, especially those seeking alternatives to asking friends or family for money. The mobile-to-mobile platform also provides a business opportunity for potential lenders that have funds available to loan to individuals in need.

The lending platform facilitates direct interaction between potential borrowers and potential lenders of funds through use of mobile devices to promote deal formation, and the lending platform also manages the transfer of funds between the lenders and borrowers upon agree-to loan terms, both for loan disbursement and loan repayment. In one case the lending platform can take the form of a purely mobile-to-mobile platform that is accessible solely as a mobile application for mobile devices, and is not accessible as a web-based or browser-based application using standard internet browsing software, whether through a mobile device or otherwise, and is not available on a computer.

Although the invention is shown and described with respect to certain embodiments, it should be clear that modifications will occur to those skilled in the art upon reading and understanding the specification, and the present invention includes all such modifications.

1. A method comprising:
at a device including one or more processors:
receiving a loan request from a first user via a first mobile device via a lending platform, the loan request specifying a requested loan amount, wherein the lending platform comprises a peer-to-peer lending market for a plurality of users;
initiating a verification process of at least one social media account or profile of the first user via an interprocess communication with a social media application installed on the mobile device of the first user, wherein the verification process includes:
logging into at least one social media account of the first user;
accessing the profile of the first user;
connecting the social media application to the lending platform; and
automatically updating information associated with the profile of the first user via an interprocess communication with the social media application;
assigning, based on results of the verification process, a credit score to the first user based on content of the at least one social media account or the profile of the first user;
providing a second user at a second mobile device, via the lending platform, the requested loan amount and the assigned credit score of the first user, wherein the second user is an individual person that is outside the first user’s social media network;
receiving a notification of a loan agreement between the first user and the second user, wherein the loan agreement comprises payment terms that includes a first payment to be paid to the first user and a second payment to be paid to the second user after a predetermined period of time;
directly accessing a funds source outside the lending platform owned or controlled by the second user and transmitting the first payment to the first user;
after the predetermined period of time, without direct action on behalf of the first user, directly accessing a funds source owned or controlled by the first user and transmitting at least a portion of the second payment to the second user; and
updating the assigned credit score of the first user after transmitting the at least a portion of the second payment to the second user.

2. The method of claim 1, wherein both of the receiving steps, both of the accessing steps, and the initiating, assigning, providing, and updating steps are carried out by a lending platform provider, and wherein the method further comprises:
determining that the first user has failed to make payment owed to the second user under the loan agreement and that the first user is in default;
determining that the lender has paid a guarantee fee to the lending platform provider; and
after both determining steps, the lending platform provider directly paying to the second user only a portion of the first user’s unpaid loan obligation under the loan agreement, wherein the lending platform provider is the original source of such payment to the second user.

3. The method of claim 1, further comprising:
obtaining a commercial credit score of the first user provided by a commercial credit scoring service, wherein the assigned credit score of the first user is based at least in part on the commercial credit score.

4. The method of claim 1, wherein the loan request from the first user includes repayment terms, including repayment time period and interest rate as determined by the first user, and wherein each user is assigned a permission level based on a respective credit score of the user, wherein the permission level of each user controls access of the user to services of the peer-to-peer lending marketplace, wherein the permission levels relate to borrowing limits and loan rates.

5. The method of claim 1, further comprising:
after providing the second user access to the lending platform, providing to the second user personal information about the first user.

6. The method of claim 1, further comprising:
after providing the second user access to the lending platform, providing the second user a list of potential borrowers, and wherein the list of potential borrowers is organized such that potential borrowers located geographically closer to the second user are presented to the second user ahead of potential borrowers located more geographically distant from the second user.

7. The method of claim 1, further comprising:
after providing the second user access to the lending platform, providing the second user a list of potential borrowers, displaying personal information and the assigned credit score of each potential borrower, and enabling the second user to select at least one of the potential borrowers to receive funds from the second user.

8. The method of claim 1, further comprising:
after providing the second user access to the lending platform, presenting the first user’s purpose for the loan request to the second user.

9. The method of claim 1, wherein at least some financial terms of the loan agreement are determined by an entity controlling the lending platform and at least partially based on the assigned credit score of the first user.

10. The method of claim 1, further comprising:
upon the first user failing to make payment owed the second user under the loan agreement, posting notice of the first user’s default on a social media account associated with the first user, other than an account associated with the lending platform.

11. The method of claim 1, wherein the assigned credit score is based at least in part upon a number of social media accounts or profiles to which access is provided by the first user.

12. The method of claim 1, further comprising:
providing the first user with personal information regarding the second user.

13. The method of claim 1, wherein the first user’s credit score takes into account events occurring within the last two weeks that effect an economic status of the first user’s geographic region.

14. A method comprising:
at a device including one or more processors:
receiving, at a lending platform provider, a loan request specifying a requested loan amount from a plurality of potential users via a lending platform;
initiating a verification process of at least one social media account or profile of each user via an interprocess communication with a social media application installed upon a mobile device of each user, wherein the verification process includes:
logging in to a user’s at least one social media account using a login credential provided by the user;
accessing the profile of the user;
connecting at least one of the social media application or the associated social media network to the lending platform; and
automatically updating information associated with the profile of the user based on results of the connection to the associated social media application or social media network via interprocess communication with the social media application or social media network;
assigning, by the lending platform provider and based on the verification process, a credit score to each of the users based at least in part on content of the at least one social media account or profile of each borrower;
providing, by the lending platform provider, information relating to the requested loan amount and the assigned credit score of each of the plurality of users to a plurality of potential lenders via the lending platform, wherein the lenders in the providing step are individual persons who are outside each user’s social media network or community and outside each other lender’s social media network or community, in both cases other than any network or community associated with the lending platform;
enabling each lender to select at least one of the users to receive loaned funds from the lender; and
after receiving a guarantee fee from the lender, and after determining that the user failed to make payment owed to the lender and is in default, the lending platform directly assuming the unpaid loan obligation owed to the lender for only a portion of the amount the user owes the lender.

15. The method of claim 14, wherein the credit score is based at least in part on the borrower’s geographic location, the borrower’s job title, the borrower’s employer, an unemployment rate, a crime rate and job creation/elimination announcements, and a timing of borrower’s receipt of payment from the borrower’s job, and wherein the credit score is determined by an artificial intelligence system.

16. The method of claim 14, wherein the user’s credit score is adjusted immediately after a loan transaction is completed.

17. The method of claim 14, further comprising:
disclosing an identity of the lender to the borrower.

18. The method of claim 14, wherein the receiving and initiating steps are carried out by a lending platform provider, which is a different entity than said plurality of lenders and said plurality of said borrower, and wherein each borrower provides bank account information directly to the lending platform.

19. The method of claim 14, wherein the lending platform provider does not determine the terms of any loan between the borrower and the lender, and wherein the lending platform provider does not provide any its own funds to the borrower as part of the loans.

20. A method comprising:
at a device including one or more processors:
receiving, by a lending platform, registration data associated with a user from a mobile device during a registration process, wherein the lending platform provides a peer-to-peer lending marketplace to a plurality of users via a verification process, wherein the lending platform further receives social media data related to the user with regard to a social media network external to the lending platform via an interprocess communication with a social media application installed upon the mobile device, wherein the verification process includes:
logging in to the user’s at least one social media account using a login credential provided by the user;
accessing a profile of the user;
connecting the social media application to the lending platform; and
automatically updating information associated with the profile of the user via the interprocess communication with the social media application;
registering a user with the lending platform;
establishing, by the lending platform, a credit score for the user at least partially based on the social media data for the user;
assigning, by the lending platform, a permission level to the user at least partially based on the user’s credit score, wherein the permission level controls a degree of access of the user to services of the peer-to-peer lending marketplace other than lending approval; and
posting a loan request from the user on the peer-to-peer lending marketplace for an amount within a borrowing limit set by the lending platform at least partially based on the credit score of that user.
